(19) United States
(12) Patent Application Publication
(10) Pub. No.: US 2009/0182450 A1
(43) Pub. Date: Jul. 16, 2009

(54) WEB APPLICATION FOR INCREASING MOLD REUSABILITY

(76) Inventor: Emmanuel Goldschmidt, Haifa (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/013,879

(22) Filed: Jan. 14, 2008

(51) Int. Cl. G06F 19/00

(52) U.S. Cl. 700/182

(57) ABSTRACT

The disclosed invention enables the increasing of the reusability of molds for manufacturing parts using casting methods. It enables manufactures the searching and locating of molds which suit their needs. Thus, when needing to cast or inject a certain part, manufactures may reuse an existing mold instead of having to manufacture the mold itself. The disclosed system and method enable manufactures the providing of two- or three-dimensional computer aided design (CAD) drawings of parts corresponding to molds which they no longer need, as well as the technical specifications of these molds. Similarly, manufactures may provide two or three-dimensional CAD drawings of the parts they wish to manufacture, as well as the technical specifications of these parts. A decision support system enables users the finding of possible matches between product casting specifications and the product specifications through an interactive web application which is updated in real-time.

### FIELD OF INVENTION

The present invention relates in general to the field of manufacturing procedures which involve the use of molds; more particularly it relates to systems and methods for increasing molds; reusability in manufacturing procedures of molded parts.

### BACKGROUND OF THE PRIOR ART

The production of almost every commercially produced product involves an assembly of different parts which are produced using molds. Most often, the production of each of the parts involves a uniquely designed mold. Thus, the planning stage of production of a new product involves the designing and manufacturing of the molds needed for producing the different parts of the product. Increasing the reusability of such molds may aid manufactures in lowering production costs, reduce production setup time and aid in reducing environmental pollution. There is therefore a need for a system and a method for aiding manufactures locate existing molds which would suit their production needs.

### SUMMARY OF THE INVENTION

Disclosed is a computerized method for increasing the reusability of existing manufacturing molds according to the Computer Aided Design (CAD) drawings of the parts produced by the molds and the technical specifications of existing molds and parts. The CAD drawings are stored in a dedicated database in which users can search. The method includes the step of producing a CAD signature for each of the CAD drawing of parts produced by the existing molds in the system database. The CAD signature is an alphanumeric representation of the graphic information in the CAD drawings.

The method also includes the loading of at least one CAD drawing of a requested part, or a sketch of that part. The drawing is loaded through a dedicated web-based interface. The method further includes the step of producing a CAD signature of the loaded CAD drawing of the requested part. The CAD signature is an alphanumeric representation of the graphic information in the CAD drawing. The method also includes the step of searching the dedicated database for an existing mold in the database which is suited for the requested part and rating retrieved existing molds in the search. The rating is determined in accordance with the estimated degree of suitability of the retrieved existing molds to the requested part. The method may be a web-based application.

The CAD drawings may be three dimensional. The suitability may be determined in accordance with the level of similarity found between the CAD signature of the existing part and the CAD signature of the requested part.

The method may also include the step of specifying the technical specifications of the requested part and mold. The suitability may be determined in accordance with the technical specifications of the existing mold and part and the technical specification of the requested mold and part. The technical specifications may include the field of use, materials, method of manufacturing, size, volume, method of connecting mold to manufacturing machine, wear condition, geographic location or price. The specification of the technical specifications may be performed using a dedicated web interface. The rating may be performed in a semiautomatic manner. The user may receive the rating through a dedicated web-based interface.

Also disclosed is a computerized system for increasing the reusability of existing manufacturing molds. Computer Aided Design (CAD) drawings of the parts produced by these molds and the technical specifications of the parts and molds are stored in a dedicated database. The system includes a web-based interface for loading at least one CAD drawing of at least one requested part and an algorithm for producing a CAD signature of CAD drawings. The system also includes a search engine for searching the dedicated database for existing molds in accordance with similarities in the CAD signature of the existing part and the CAD signature of the requested part, and an algorithm for rating retrieved existing molds by the search engine wherein the rating is determined in accordance with the level of suitability of the parts produced by the retrieved molds and the requested part. The system may be a web-based application.

The CAD drawings may be three dimensional. The suitability between the molds may be determined in accordance with the level of similarity found between the CAD signature of the part produced by the existing molds and the CAD signature of the requested part. The system may also include an interface of loading technical specifications of the requested part and mold. The interface may be web-based. The suitability between the molds may be determined in accordance with the level of similarity found between the technical specifications of the existing molds and parts and the technical specifications of the requested mold and part.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a flowchart illustrating the principal components of the disclosed method in accordance with embodiments of the present invention;

FIG. 2 is a flowchart illustrating the principal components of the decision support system algorithm in accordance with embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is a new and innovative web-based system and method which enables the increasing of the reusability of molds for manufacturing parts using casting and injection methods. According to embodiments of the present invention the proposed system and method enable manufactures to search for molds which suit their needs and contact the owners of these molds. Thus, when needing to produce a certain part, manufactures may reuse an existing mold instead of having to manufacture the mold itself. The disclosed system and method enable manufactures the providing of two- or three-dimensional computer aided design (CAD) drawings of parts corresponding to molds which they no longer need, as well as the technical specifications of these molds. Similarly, manufactures may provide two- or three-dimensional CAD drawings of the parts they wish to manufacture, or a sketch drawing of that part, as well as the technical specifications of these parts. The proposed system and method provide a decision support system which enables users of the system to find possible matches between product production specifications and the product specifications through an interactive web application which is updated in real-time.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

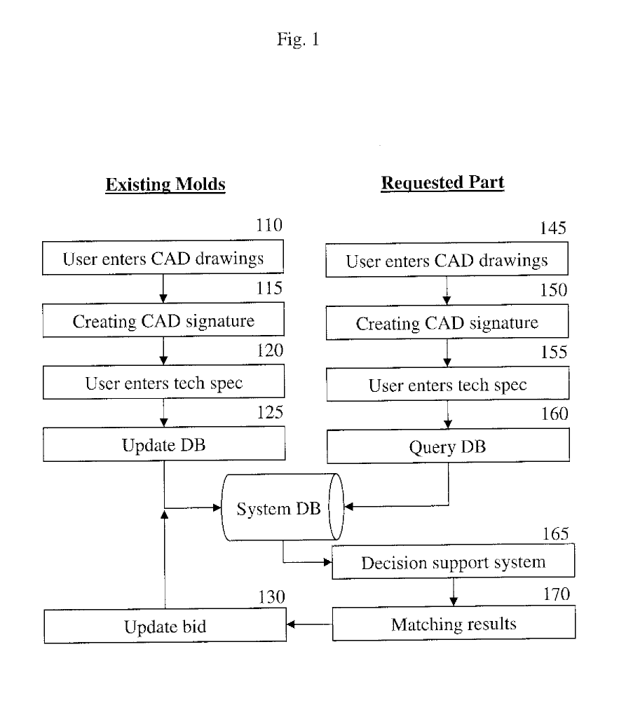

The proposed system and method enable users to find a mold which matches their three- or two-dimensional Computer Aided Design (CAD) model using a web-based application. FIG. 1 is a flowchart illustrating the principal components of the disclosed method in accordance with embodiments of the present invention. Manufactures who have molds which can be reused enter details about the parts and their molds to the database of the system through a dedicated web-based interface. The three- and two-dimensional CAD drawings of the part which can be produced by the molds are loaded into the system through the interface (step 110). Then the system produces a CAD signature according to the CAD drawings (step 115). The CAD signature is an alphanumeric descriptor of the two- and three-dimensional CAD drawings which is automatically produced by the system. The automatic production of the CAD signature is performed in accordance with the visual characteristics of the CAD drawings. Thus, two identical CAD drawings would yield the same CAD signature, and CAD drawings which have similar features will have similar CAD signatures.

In addition to the CAD drawings, the owner of the mold specifies technical details concerning the mold and the part through a dedicated web-based interface (step 120). The technical details include the type of mold, its materials, size, volume, production means, field of manufacturing, the method of connecting the mold to the casting or injecting machine, and any other essential information. The owner of the mold may be asked to specify additional information such as the number of parts produced by the mold, specific information about the part, the global location of the mold and requested price. All the information about the mold and the part is stored in the system database (step 125).

Users wishing to find a mold load two- or three dimensional CAD drawings of the part they aim to produce with a mold, through a dedicated web-based interface (step 145). According to some embodiments of the present invention, the user may also load a sketch of the part and not a full and complete CAD design. Then the system produces a CAD signature according to the CAD drawings (step 115). As mentioned above, the CAD signature is an alphanumeric descriptor of the Two- and three-dimensional CAD drawings which is automatically produced by the system. The CAD signature is a coded description of the shape of the part. Thus, two identical parts would yield identical CAD signatures, and parts which have similar features will have similar CAD signatures.

Next, users specify the technical details of the required mold, such as the type of mold, its materials, size, volume, production means, field of manufacturing, the method of connecting the mold to the casting or injecting machine, price range, the geographic location of the mold, its condition and any other essential information about the part or mold (step 155). According to some embodiments users of the system may provide weights reflecting the relative importance of the different details. For instance, users may prioritize the geographic location of the mold as highly important, since they do not wish to pay shipping costs, while for others the cost of the mold may be given much more weight.

According to the information provided by the users the system queries the database in search for the best fit (step 160). The system retrieves all molds in the database whose CAD signature of the part produced by them shows high levels of similarity to the CAD signature of the drawings of the requested part provided by the user. The system then executes the algorithm of the decision support system to select the best candidates for the user (step 165). The algorithm of the decision support system is described below. Finally, the system presents the matching results to the user (step 170). According to some embodiments of the present invention the system may also enquire with owners of molds whether they wish to update their bids provided that their molds were found suitable for a user but their price for the mold was too high (step 130).

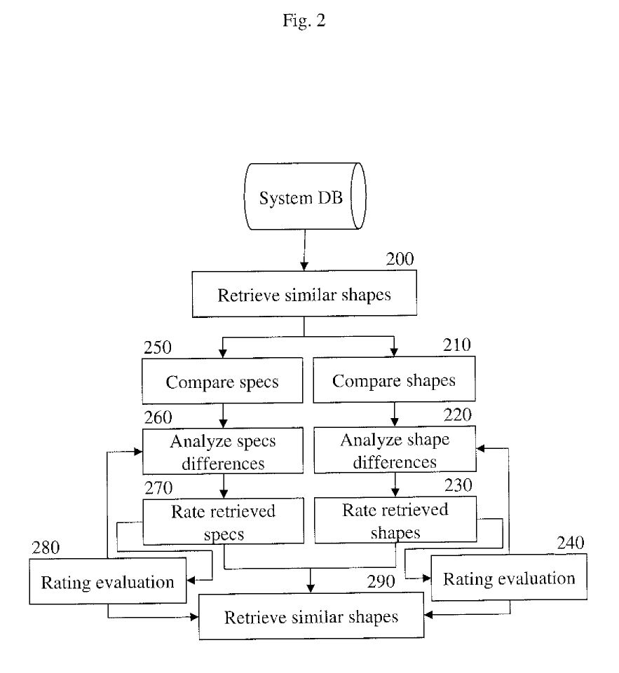

The decision support system algorithm facilitates the selection of the most suitable mold for the user. FIG. 2 is a flowchart illustrating the principal components of the decision support system algorithm in accordance with embodiments of the present invention. First, the system retrieves from the database the molds of the parts with the graphic characteristics which are most similar to those provided by the user (step 200). Then, the algorithm compares the graphic characteristics of the parts to the requested graphic characteristics specified by the user (step 210). At the next step the system analyzes the geometrical and topological differences between the retrieved parts and the requested part (step 220). For instance, the algorithm may compare volumes, surface areas, moments of inertia, etc. nonidentical features between each of the retrieved parts and the characteristics specified by the user. Similarly, the algorithm may find the position in three-dimensional space of maximal overlap between the two parts, and measure the non-overlapping volumes. According to the analysis of the graphic differences between each of the retrieved parts and the requested part the algorithm rates each of the retrieved molds (step 230).

According to some embodiments of the present invention this rating process may be semiautomatic. In a semiautomatic process an engineer reviews the analysis performed by the algorithm and rating results, corrects the results, and evaluates the quality of this analysis (step 240). The evaluation provided by the engineer may not only influence the rating of each of the retrieved molds, but may also update the analysis procedure performed by the algorithm.

The algorithm compares the specifications, i.e. the non-graphic characteristics of the retrieved molds and their parts, as specified by the molds owners and the specifications of the requested mold and part provided by the user (step 250). Next, the algorithm analyzes the differences between the specifications of the retrieved molds and parts and those provided by the user (step 260). This analysis is performed in accordance with the weights of the relative importance of each of the specifications as provided by the user. Additionally, the algorithm may also hold predefined weights for each of the specifications. The specifications of the retrieved molds and parts are rated according to this analysis (step 270).

According to some embodiments of the present invention this rating process may be semiautomatic. In a semiautomatic process an engineer reviews the analysis performed by the algorithm and rating results, corrects the results, and evaluates the quality of this analysis (step 280). The evaluation provided by the engineer may not only influence the rating of each of the retrieved molds, but may also update the analysis procedure performed by the algorithm.

Finally the algorithm calculates the combined rating of each of the retrieved molds (step 290). The combined rating is calculated according to the rating of the similarity of the shapes and the rates of the suitability of the specifications. The relative rate of each of these components is predetermined. According to some embodiments of the present invention the relative rate of each of the components may be determined in a semiautomatic manner. According to these embodiments an engineer may perform modifications in the calculations of the combined rating.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A computerized method for increasing the reusability of existing manufacturing molds, wherein Computer Aided Design (CAD) drawings of the parts produced by said molds and technical specifications of said existing parts and molds are stored in a dedicated database, said method comprising the steps of:
producing a CAD signature for each of said CAD drawing of said parts produced by said existing molds in said system database, wherein said CAD signature is an alphanumeric representation of the graphic information in said CAD drawing;
loading at least one CAD drawing of a requested part, wherein said drawing is loaded through a dedicated web-based interface;
producing a CAD signature of said loaded CAD drawing of said requested part, wherein said CAD signature is an alphanumeric representation of the graphic information in said CAD drawing;
searching said dedicated database for an existing mold in said database which is suited for said requested part;
rating retrieved existing molds in said search, wherein said rating is determined in accordance with the estimated degree of suitability of said retrieved existing molds to said requested part.

2. The method of claim 1 wherein said method is a web-based application.

3. The method of claim 1 wherein said CAD drawings are three dimensional.

4. The method of claim 1 wherein said suitability is determined in accordance with the level of similarity found between said CAD signature of said parts of said existing molds and said CAD signature of said requested part.

5. The method of claim 1 further including the step of specifying the technical specifications of said requested part and mold, wherein said suitability is determined in accordance with said technical specifications of said existing part and mold and said technical specification of said requested part and mold.

6. The method of claim 4 wherein said technical specifications include at least one of the following: field of use, materials, method of manufacturing, size, volume, method of connecting mold to molding machine, wear condition, geographic location, price.

7. The method of claim 4 wherein said specification of said technical specifications is performed using a dedicated web interface.

8. The method of claim 1 wherein said rating is performed in a semiautomatic manner.

9. The method of claim 1 wherein said user receives said rating through a dedicated web-based interface.

10. A computerized system for increasing the reusability of existing casting and injection molds, wherein Computer Aided Design (CAD) drawings of parts produced by said existing molds and technical specifications of said parts and molds are stored in a dedicated database, said system comprising:
a web-based interface for loading at least one CAD drawing of at least one requested part;
an algorithm for producing a CAD signature of CAD drawings;
a search engine for searching said dedicated database for existing molds in accordance with similarities in said CAD signature of said existing part and said CAD signature of said requested part;
an algorithm for rating retrieved existing molds by said search engine wherein said rating is determined in accordance with the level of suitability of said parts produced by said retrieved molds and said requested part.

11. The system of claim 10 wherein said system is a web-based application.

12. The system of claim 10 wherein said CAD drawings are three dimensional.

13. The system of claim 10 wherein said suitability is determined in accordance with the level of similarity found between said CAD signature of said part produced by said existing molds and said CAD signature of said requested part.

14. The system of claim 10 further including an interface of loading technical specifications of said requested part and mold.

15. The system of claim 14 wherein said interface is web-based.

16. The system of claim 10 wherein said suitability is determined in accordance with the level of similarity found between said technical specifications of said existing part and molds and said technical specifications of said requested part and mold.

17. The system of claim 10 wherein said technical specifications include at least one of the following: field of use, materials, method of manufacturing, size, volume, method of connecting mold to molding machine, wear condition, geographic location, price.
